(19) United States
(12) Patent Application Publication
(10) Pub. No.: US 2008/0208739 A1
(43) Pub. Date: Aug. 28, 2008

(54) TRANSACTIONAL SERVICES ASSOCIATED WITH MOBILE DEVICES

(76) Inventor: Mark E. Phillips, Seattle, WA (US)

Correspondence Address: OLYMPIC PATENT WORKS PLLC, P.O. BOX 4277, SEATTLE, WA, 98104, US

(21) Appl. No.: 11/679,338

(22) Filed: Feb. 27, 2007

(51) Int. Cl. G06Q 40/00; H04Q 7/20

(52) U.S. Cl. 705/40; 455/466

(57) ABSTRACT

Methods, apparatuses, and articles for a service provider capable of providing transactional services to mobile device users are described herein. In one embodiment, the service provider is adapted to receive a request from a mobile device known to the service provider to transfer value associated with the mobile device, the request specifying a recipient of the value and, in response, request, of a financial institution having an account associated with the mobile device, the transfer of value from the account to an account associated with the specified recipient. Also, in some embodiments, the service provider is adapted to receive a request from a mobile device known to the service provider to transfer value associated with the mobile device, the request specifying a mobile device service feature to be purchased with the value and, in response, exchange the value for the mobile device service feature.

### TECHNICAL FIELD

Embodiments of the present invention relate to the field of data processing, in particular, to methods and apparatuses for transactional services associated with mobile devices.

### BACKGROUND

Advances in processor, memory, and wireless technologies have led to the proliferation of mobile electronic devices (hereinafter, simply mobile devices). Typical mobile devices, such as wireless mobile phones and personal digital assistants (PDA) provide a wide array of services, such as cellular calling, email, text messaging, calendar and address book services, media object acquisition and playback services, and camera services, among many others. In acquiring media objects, cell phone minutes, or other goods or services available over the Internet, mobile devices often provide users with the same functionalities as other computing devices. For example, users may enter credit card information into browsers of mobile devices and may submit the credit card information to make acquisitions.

Concurrently, merchants such as retailers, wholesalers, and service providers offer customers a wide variety of payment methods. Customers can often pay via any of cash, check, money order, gift card, credit card, and debit card. The variety of payment methods, combined with the fact that many merchants do not accept certain types of credit cards, etc., requires customers to carry on their persons instruments associated with a large number of payment methods. Carrying this wide array of payment method instruments is often quite burdensome to many customers.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of various embodiments of the present invention;

FIG. 2 illustrates a flow chart view of selected operations of the methods of various embodiments of the present invention; and

FIG. 3 illustrates an example computer system suitable for use to practice various embodiments of the present invention.

### DETAILED DESCRIPTION OF ILLUSTRATIVE EMBODIMENTS

Illustrative embodiments of the present invention include, but are not limited to, methods and apparatuses for a service provider capable of providing transactional services to mobile device users. In one embodiment, the service provider is adapted to receive a request from a mobile device known to the service provider to transfer value associated with the mobile device, the request specifying a recipient of the value, and in response, request, of a financial institution having an account associated with the mobile device, the transfer of value from the account to an account associated with the specified recipient. Also, in some embodiments, the service provider is adapted to receive a request from a mobile device known to the service provider to transfer value associated with the mobile device, the request specifying a mobile device service feature to be purchased with the value, and in response, exchange the value for the mobile device service feature.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

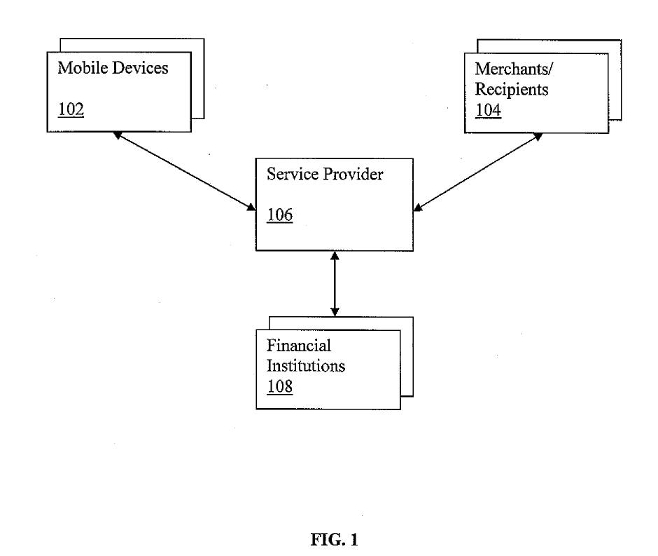

FIG. 1 illustrates an overview of various embodiments of the present invention. As illustrated, a service provider 106 may provide transactional services to users of mobile devices 102 and/or merchants/recipients 104. In some embodiments, service provider 106 may facilitate transfers of value from an account of a mobile device 102 user to an account of merchant/recipient 104 through interaction with one or more financial institutions 108, the financial institution(s) 108 performing the transfer and notifying the service provider 106 of the success or failure of the transfer. In various embodiments, the transfer may be payment for goods or services or a donation. In one embodiment, the transfer may be initiated by a mobile device 102 request, the mobile device 102 having received from service provider 106 a request for payment sent on behalf of merchant/recipient 104. Mobile devices 102 and/or merchants/recipients 104 may be devices known by service provider 106 in advance—through registration, for example—and merchants/recipients 104 may also be associated with mobile devices. Also, in other embodiments, service provider 106 may facilitate mobile devices 102 in exchanging value for mobile device service features, such as cellular calling minutes, text messages, and/or media object downloads.

In various embodiments, mobile devices 102, and computing/communication devices of merchants/recipients 104, service provider 106, and/or financial institutions 108 may be connected by one or more networking fabrics. The networking fabrics may be any sort of networking fabrics known in the art, such as one or more of local area networks (LAN), wide area networks (WAN), the Internet, and cellular networks associated with cellular service providers. For example, mobile devices 102 may be connected to computing/communication devices of service provider 106 through at least one cellular network of a cellular service provider, computing/communication devices of merchants/recipients 104 may be connected to computing/communication devices of service provider 106 by the same or other cellular networks, or even via the Internet, and computing/communication devices of financial institutions 108 may be connected to computing/communication devices of service provider 106 through a private WAN or a secured Internet connection such as a virtual private network (VPN). The parties to the connections may further use any communication protocols known in the art, such as the Hypertext Transfer Protocol (HTTP) or the wireless markup language (WML), and any transport protocol known in the art, such as the Transmission Control Protocol/Internet Protocol (TCP/IP) suite of protocols. As mentioned, mobile devices 102, and computing/communication devices of merchants/recipients 104, service provider 106, and/or financial institutions 108 may have networking and/or cellular interfaces to facilitate networked/cellular communication across some or all of the one or more networking fabrics.

As is shown, mobile devices 102 may be any sort of mobile devices known in the art, such as wireless mobile phones, personal digital assistants (PDA), and laptop computers. Mobile devices 102 may comprise a plurality of communication means, such as cellular calling functionalities, email services, and text messaging services, such as services enabling Simple Messaging Service (SMS) messaging. Also, mobile devices 102 may include web browsing and media object acquisition and playback capabilities, among other features.

In various embodiments, users of mobile devices 102 may register with service provider 106 for its transactional services. Service provider 106 may also be the cellular service provider of the phone, potentially making registration unnecessary or optional. In embodiments where registration is necessary, mobile devices 102 may enable their users to register by calling customer service personnel associated with the service provider 106 that can register the user, or email or text message the service provider to register. In other embodiments, using mobile devices 102 or other computing devices, users may access a web portal associated with the service provider 106 to register. Registration may include providing personal information about the user, mobile device 102 information about the features, phone number, and cellular service provider of the mobile device 102, and account information about one or more accounts a user has with one or more financial institutions 108, such as debit or credit accounts.

Once registered, or identified in some other fashion to service provider 106, mobile devices 102 may use service provider 106's transactional services. For example, if shopping at a physical location of a merchant 104 and desiring to purchase goods/services of the merchant 104, the user of a mobile device 102 may submit a request to service provider 106 for payment to merchant 104, allowing the user to purchase the goods/services without the added hassle of using (and therefore having to carry with the user) cards, checks, or cash. Such a request may include the desired payment method, if multiple methods are associated with the user and mobile device 102 by service provider 106. In some embodiments, mobile devices 102 may receive requests from merchants 104, via service provider 106, for payment, and may in turn direct payment to the merchant 104. Also, mobile devices 102 may be used to transfer value, either as a payment or a donation, to other recipients 104, including companies and individuals. For example, a user, through mobile device 102, may direct service provider to donate value to a charity or to pay a bill. Further, mobile devices 102 may be used to purchase mobile device service features, such as cellular service minutes, text messages, and media object downloads. In various embodiments, mobile devices 102 may be used in conjunction with service provider 106 in any location offering wireless/cellular coverage to mobile device 102.

As illustrated, merchants/recipients 104 may be associated with any sort of mobile or other computing device known in the art. Merchants/recipients 104 may be associated with personal computers (PC), workstations, servers, routers, mainframes, modular computers within blade servers or high-density servers, PDAs, or wireless mobile devices. In some embodiments, merchants/recipients may be associated with their own mobile devices 102 having service accounts with service provider 106. In other embodiments, merchants/recipients 104 may register with service provider 106 without having mobile devices 102. In such other embodiments, merchants/recipients 104 may only be capable of requesting payment from mobile device 102 users and of receiving such payments. In yet other embodiments, merchants/recipients 104 may not be registered with service provider 106, but service provider 106 may have enough identifying information regarding merchants/recipients 104 to facilitate a transfer of value to merchants/recipients 104. In various embodiments, if a user of a mobile device 102 presents a good/service the user wishes to purchase to personnel of a merchant 104, and indicates to the personnel that the user wishes to pay via mobile device 102, the personnel may ascertain the phone number of mobile device 102 and may send a request to service provider 106 for payment from mobile device 102. Upon completion of the request, merchant 104 may receive an indication of its success or failure from service provider 106.

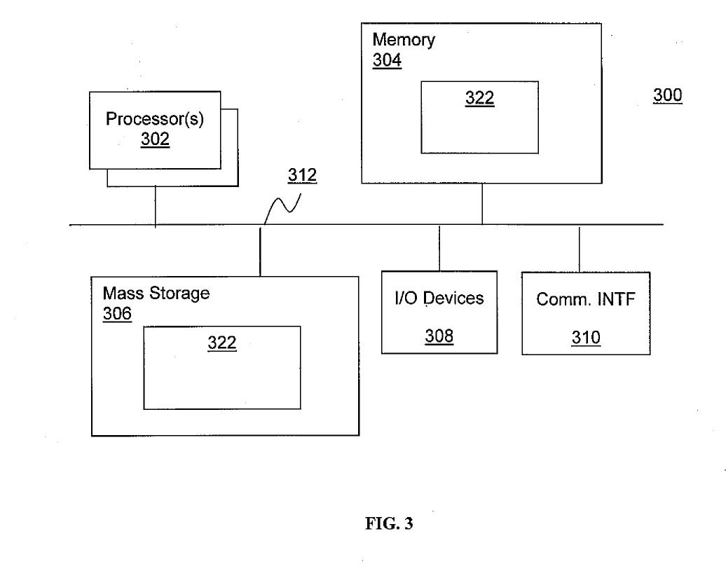

In various embodiments, computing/communication devices of service provider 106 may be any single- or multi-processor or processor core central processing unit (CPU) computing system. Service provider 106 computing/communication devices may be a personal computer (PC), a workstation, a server, a router, a mainframe, or modular computers within a blade server or high-density server. In some embodiments, service provider 106 computing/communication devices may have one or more cellular/networking interfaces to facilitate communication with mobile devices 102 and computing/communication devices of merchants/recipients 104 and/or financial institutions 108. An exemplary single-/multi-processor or processor core computing system of service provider 106 is illustrated by FIG. 3 and is described in greater detail below. Hereinafter, including in the claims, processor and processor core shall be used interchangeably, with each term including the other.

In some embodiments, service provider 106 may offer registration functionalities to mobile devices 102 and merchants/recipients 104 to facilitate mobile device 102 users and merchants/recipients 104 in providing information needed for the transactional services offered by service provider 106. Registration functionalities may be implemented in any manner known in the art, such as an application programming interface (API) or various functions capable of extracting registration information from a text message, such as an SMS message or an email message. In some embodiments, service provider 106 may expose a web page form that is accessible to registrants, such as mobile devices 102, the registrants viewing the form with a web browser and inputting the necessary data into the form. In one embodiment, personnel associated with service provider 106 may act as customer service representatives answering calls made by users of mobile devices 102 and/or merchants/recipients 104 and entering the information for those registrants necessary for their registration. Each registrant may then be associated with one or more records in a database of service provider 106.

Information collected from registrants and stored in the records may be modest or extensive, depending upon the variety of transactions the registrant desires to engage in. Basic personal information, such as name, address, email address, and phone number may be collected, as well as information associated with the mobile device 102 to be associated with the registration, such as wireless service provider, wireless account number, communication features of the phone (email, SMS, etc.), and a mobile device 102 phone number. In addition, payment methods that the registrant wishes to use, such as debit and credit card accounts, may be provided along with the relevant name(s) on the account, the account numbers, card expiration dates, and names of the financial institutions 108 associated with the payment method accounts may also be collected. Further, information about service features associated with the mobile device 102, such as cellular minutes, text messages, and media object downloads may be collected and stored. Other information may also be collected and stored. Thus, the above recitation is in no way intended to fully set forth all collected and stored data.

In various embodiments, merchants/recipients need not be associated with a mobile device 102, and may instead merely provide corporate and account information, such as the information described above. In one embodiment, merchants 104 may register to offer mobile device 102 users additional features, such as the ability to add minutes, to download songs, or to deposit cash into a “stored value account” to be associated with a user's mobile device 102. Then stored value account may be used to make payments and purchase service features in lieu of using one of the payment methods. Such merchants could charge users a fee for adding value to a stored value account, and such accounts may or may not be automatically created for users upon registration.

After registering, users of mobile devices 102 may use those devices to communicate with service provider 106 to request various transactional services from service provider 106. In some embodiments, service provider 106 may receive directives to pay a merchant 104 or to transfer value to a recipient 104. The directive may include information identifying the merchant/recipient 104 and the amount to be transferred, as well as a preferred method of payment, which may designate a preferred one of the accounts. In some embodiments, an account may be designated as a default and may be used automatically unless other account information is provided. In one embodiment, mobile device service features known to the service provider may be selected as a custom payment method, enabling users to trade service features such as minutes for goods/services or to donate such features. The directive to transfer value may include many different types of transactions, such as purchases of goods/services, repayments, and donations and each of the various transactions may occur in a similar fashion. In other embodiments, the directive to transfer may be solicited by a merchant/recipient 104. For example, service provider 106 may receive from a merchant/recipient 104 a request for payment from a user of a mobile device 102. The service provider 106 may in turn provide the request to the mobile device 102, and may receive, in response, a directive to transfer value. In various embodiments, the recipient 104 identified by the directive to transfer value maybe the same individual as the user of mobile device 102, with the directive effectively requesting the transfer of value from one of the user's accounts to another.

In response to receiving a directive to pay value to a merchant/recipient 104, service provider 106 may request of a financial institution 108 (associated with the account selected by the mobile device 102 user as the payment method account) that the financial institution 108 transfer value to an account of a merchant/recipient 104. The request may include names of both the user of mobile device 102 (the transferor) and the merchant/recipient 104 (the transferee) and, in some embodiments, account information about one or both. If the account of the merchant/recipient 104 is associated with a different financial institution 108, the request may also provide identifying information regarding that other financial institution 108. After making the request, the financial institution 108 may require service provider 106 to provide authentication information regarding the user and the request, such as a user login and password, as well as some indication of the directive to transfer value received from the user. After sending this information, the service provider 106 may receive notification of the success or failure of the transfer from financial institution 108. The service provider 106 may then notify one or both of the mobile device 102 and the merchant/recipient 104 of the success or failure, completing the transaction.

In some embodiments, the directive received by service provider 106 from mobile device 102 may be a directive to acquire service features rather than a directive to transfer value. Service features that may be purchased may be any known in the art, such as cellular calling minutes, text messages, or media object downloads. The service features may be purchased directly from the service provider 106 or from a third party. Value to be exchanged for the features may be taken from one of the above mentioned stored value accounts or from an account associated with a financial institution 108, in the manner described above.

In various embodiments, each financial institution 108 may participate in the method of the invention via a single- or multi-processor or processor core central processing unit (CPU) computing system. Each financial institution 108 computer system may be a personal computer (PC), a workstation, a server, a router, a mainframe, or modular computers within a blade server or high-density server. In some embodiments, each financial institution's 108 computer system may have one or more networking interfaces to facilitate communication with computer systems of service provider 106 and with computer systems of other financial institutions 108. An exemplary single-/multi-processor or processor core computing system of a financial institution 108 is illustrated by FIG. 3 and is described in greater detail below.

In some embodiments, a financial service 108 may be connected to service provider 108 via a private WAN or via a public WAN, such as the Internet. If the connection is through a public WAN, VPN technology or some similar security technique may be used to ensure secure transmission of data between service provider 106 and financial institution 108. Once a connection is established, financial institution 108 may receive requests from service provider 106 for transfers of funds from one account, associated with financial institution 108 to another, which may or may not be associated with financial institution 108. The requests may include one or more pieces of identifying information, such as account numbers of the transferor and transferee, names of the transferor and transferee, etc. In one embodiment, account numbers may be required. In another, account numbers may be ascertained by financial institution 108 based on other identifying information. Accounts associated with such account numbers may include credit and debit accounts, among others. Also, upon receiving a request from service provider 106, financial institution 108 may attempt authentication from service provider 106 of the user's request. Such authentication information may include a user login and password and a record of the user's request through mobile device 102.

In various embodiments, the financial institution 108 may then attempt to verify that the transferor has sufficient funds in the specified account to make the transfer. Financial Institution 108 may accomplish this simply by checking the account balance. If the account lacks sufficient funds, financial institution 108 may notify the service provider 106 of the failure of the transfer.

If, however, the transferor account has sufficient funds, financial institution 108 may perform the transfer. If both accounts are associated with the same financial institution 108, that financial institution 108 need only directly credit one account and debit the other to achieve the transfer. If, however, the transferee account belongs to a different financial institution 108, the institution 108 receiving the transfer request may establish a connection with the other financial institution 108 to accomplish the transfer of funds. Such a connection may also be a secure connection, like the secure connection described above between provider 106 and institution 108. Transfers of value between financial institutions 108 are well known in the art and need not be described further. In some embodiments, following the attempted transfer, financial institution 108 may notify service provider 106 of the success or failure of the transfer.

In various embodiments, financial institution 108 may also be adapted to convert currency for transfers of value between accounts having differing currencies or at least to calculate the value of an amount to be transferred in a differing currency so that the appropriate amount can be transferred without converting currency. In various embodiments, the financial institution 108 determines whether to convert of merely calculate and transfer based on the currency requirements of the transferee.

In one embodiment, both the transferor and transferee may be the same mobile phone 102 user, and both accounts may be associated with the same mobile phone 102. Thus, mobile phone 102 may be used as a de facto bank card for transferring funds between accounts at the same or differing financial institutions.

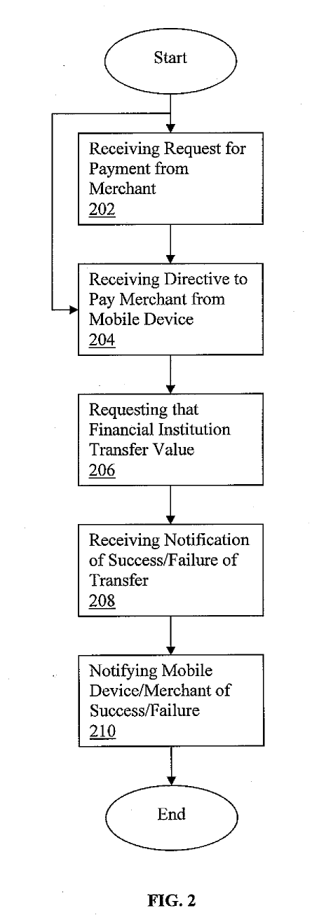

FIG. 2 illustrates a flow chart view of selected operations of the methods of various embodiments of the present invention. As illustrated, a service provider offering transactional services, including the facilitating of purchases of goods/services, may receive a request from a merchant or recipient for payment from a customer associated with a mobile device, such as a wireless mobile phone, a PDA, or a laptop, block 202, the customer and associated mobile device being known to the service provider in advance. In one embodiment, the merchant/recipient may also be associated with a mobile device and/or may be known in advance to the service provider. In response, the service provider may provide the payment request to the customer through the mobile device. In various embodiments, the service provider may then receive a directive to pay the merchant/recipient from the user's mobile phone, block 204. The payment may be for goods purchased or being purchased, or for services tendered or to be tendered. In some embodiments, the user may issue a directive to pay a merchant, block 204, without receiving any request for payment from the merchant/recipient. In such embodiments, rather than directing payment for goods or services to a merchant, the directive may instead or also direct donation of value to a recipient or repayment of an owed amount. The directive to pay may include an indication of a desired payment method, such as credit, debit, or a custom method, such as the offering of mobile device service features as payment. In sending the directive to the service provider, the mobile device may use one or more of an SMS utility, an email utility, a web browser utility, and a voice input utility.

Upon receiving a directive to transfer value/pay a merchant, the service provider may request a financial institution having an account associated with the customer/user of the mobile phone that the institution transfer value from that account to an account associated with the merchant/recipient, block 206. In some embodiments, the account associated with the merchant/recipient may belong to another financial institution. At some later point in time, the service provider may then receive in return from the financial institution an indication of success or failure of the transfer, block 208, which may include reasons the transfer failed, if failure occurs. Following receipt of the notification, the service provider may then notify one or both of the customer/user of the mobile device and the merchant/recipient of the success or failure of the transaction, block 210.

FIG. 3 illustrates an example computer system suitable for use to practice various embodiments of the present invention. As shown, computing system 300 includes a number of processors or processor cores 302 and system memory 304. For the purpose of this application, including the claims, the terms “processor” and “processor cores” may be considered synonymous, unless the context clearly requires otherwise. Additionally, computing system 300 includes mass storage devices 306 (such as diskette, hard drive, compact disc read only memory (CDROM) and so forth), input/output devices 308 (such as keyboard, cursor control and so forth), and communication interfaces 310 (such as network interface cards, modems and so forth). The elements are coupled to each other via system bus 312, which represents one or more buses. In the case of multiple buses, they are bridged by one or more bus bridges (not shown).

Each of these elements performs its conventional functions known in the art. In particular, system memory 304 and mass storage 306 may be employed to store a working copy and a permanent copy of the programming instructions implementing one or more components to effectuate the client, the service provider or merchant functions earlier described, herein collectively denoted as 322. The various components may be implemented by assembler instructions supported by processor(s) 302 or high-level languages, such as C, that can be compiled into such instructions.

The permanent copy of the programming instructions may be placed into permanent storage 306 in the factory or in the field, through, for example, a distribution medium (not shown) such as a compact disc (CD) or through communication interface 310 (from a distribution server (not shown)). That is, one or more distribution media having an implementation of the agent program may be employed to distribute the agent and program various computing devices.

The constitution of these elements 302-312 are known and, accordingly, will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present invention. This application is intended to cover any adaptations or variations of the embodiments discussed herein. Therefore, it is manifestly intended that the embodiments of the present invention be limited only by the claims and the equivalents thereof.

What is claimed is:

1. A method comprising:
receiving, by a service provider, from a mobile device, a directive to pay a value to a merchant on behalf of a customer of the merchant, wherein the mobile device is associated with the customer and one or more payment methods;
requesting, in response, by the service provider, a financial institution associated with at least one of the one or more payment methods to transfer value from an account of the customer to an account of the merchant; and
receiving, by the service provider, a notification of success or failure of the requesting of the financial institution.

2. The method of claim 1, further comprising notifying, by the service provider, one or both of the customer and the merchant of the success or failure of the requested transfer of value.

3. The method of claim 1, wherein the payment methods include one or more of debit and credit methods.

4. The method of claim 1, wherein the account of the merchant and the account of the customer are associated with different financial institutions.

5. The method of claim 1, wherein the mobile device is a selected one of a wireless mobile phone, a PDA, or a laptop.

6. The method of claim 1, wherein the mobile device is adapted to communicate with the service provider using at least one of a SMS utility, a web browser utility, an email utility, or a voice input utility.

7. The method of claim 1, wherein the merchant is associated with another mobile device.

8. The method of claim 1, wherein said receiving the directive from the mobile device to pay the value is in response to a request by the merchant, of the mobile device, for payment.

9. The method of claim 1, wherein the transfer of value is a selected one of a payment for goods the customer purchased or is purchasing from the merchant, a payment for services to the customer tendered or to be tendered by the merchant, or a repayment for an obligation the customer owed to the merchant.

10. A service-provider apparatus comprising:
a processor; and
a service module operated by the processor and adapted to
receive a request from a mobile device known to the service-provider apparatus to transfer value associated with the mobile device, the request specifying a recipient of the value, and
in response, request, of a financial institution having an account associated with the mobile device, the transfer of value from the account to an account associated with the specified recipient.

11. The service-provider apparatus of claim 10, wherein the transfer of value is facilitated by one or more payment methods, including debit and credit methods.

12. The service-provider apparatus of claim 10, wherein the account of the recipient and the account of the customer are associated with different financial institutions.

13. The service-provider apparatus of claim 10, wherein the recipient is associated with another mobile device.

14. The service-provider apparatus of claim 10, wherein said receiving the request from the mobile device to transfer the value is in response to a request by the recipient, of the mobile device, for payment.

15. The service-provider apparatus of claim 10, wherein the transfer of value is a selected one of a payment for goods, a payment for services, a repayment, and a donation.

16. A service-provider apparatus comprising:
a processor; and
a service module operated by the processor and adapted to
receive a request from a mobile device known to the service-provider apparatus to transfer value associated with the mobile device, the request specifying a mobile device service feature to be purchased with the value, and
in response, exchange the value for the mobile device service feature.

17. The service-provider apparatus of claim 16, wherein the mobile device service feature includes one or more of a number of cellular service minutes, a number of text messages, and a number of media object downloads.

18. The service-provider apparatus of claim 16, wherein the mobile device is a selected one of a wireless mobile phone, a PDA, or a laptop.

19. The service-provider apparatus of claim 16, wherein the mobile device is adapted to communicate with the service provider using at least one of a SMS utility, a web browser utility, an email utility, or a voice input utility.

20. An article of manufacture comprising:
a storage medium; and
a plurality of programming instructions stored on the storage medium and configured to program an apparatus to enable the apparatus to implement a financial service configured to
receive a request from a service provider on behalf of a mobile device to transfer a specified value from an account known to the financial service to a recipient specified by the request, wherein the account is associated with the mobile device,
determine whether the value specified by the request is available in the account for transfer, and
if the value is available for transfer, transfer the value from the account associated with the mobile device to an account associated with the recipient.

21. The article of claim 20, wherein the account of the recipient is associated with another financial service.

22. The article of claim 21, wherein the programming instructions are further configured to program an apparatus to enable the apparatus to implement a financial service configured to establish a connection to the other financial service to facilitate transfer of the value.

23. The article of claim 20, wherein the account is one of a debit account and a credit account.

24. The article of claim 20, wherein the programming instructions are further configured to program an apparatus to enable the apparatus to implement a financial service configured to notify the service provider of the success or failure of the transfer.

25. The article of claim 20, wherein the programming instructions are further configured to program an apparatus to enable the apparatus to implement a financial service configured to 1) convert currency associated with the value to another currency and/or 2) calculate an equivalent of the value in a currency different from that of the value.

26. The article of claim 20, wherein the programming instructions are further configured to program an apparatus to enable the apparatus to implement a financial service configured to require authentication from the service provider prior to said transfer.

27. The article of claim 20, wherein the recipient is the mobile device, and both accounts belong to a person associated with the mobile device.
